(19) United States
(12) Patent Application Publication
(10) Pub. No.: US 2006/0207252 A1
(43) Pub. Date: Sep. 21, 2006

(54) Controller for internal combustion engine with supercharger

(75) Inventors: Daiji Isobe, Toyohashi-city (JP); Kayoko Kimoto, Hekinan-city (JP)

Correspondence Address: NIXON & VANDERHYE, PC, 901 NORTH GLEBE ROAD, 11TH FLOOR, ARLINGTON, VA, 22203, US

(73) Assignee: Denso Corporation, Kariya-city (JP)

(21) Appl. No.: 11/365,814

(22) Filed: Mar. 2, 2006

(30) Foreign Application Priority Data
Mar. 2, 2005 (JP) 2005-57571

(51) Int. Cl. F02D 23/00; F02B 33/44

(52) U.S. Cl. 60/601; 60/609; 60/605.2

(57) ABSTRACT

A torque base control unit calculates target torque on the basis of accelerator position and engine speed and, on the basis of the target torque, further executes calculation of a fuel injection amount and calculation of target boost pressure. An assist control unit calculates target compressor power on the basis of the target boost pressure calculated by the torque base control unit and target air volume calculated from the target torque and also calculates actual compressor power on the basis of exhaust information. On the basis of the power difference between the target compressor power and the actual compressor power, assist power of an auxiliary compressor provided upstream of a turbocharger is calculated.

### CROSS REFERENCE TO RELATED APPLICATION

This application is based on Japanese Patent Application No. 2005-57571 filed on Mar. 02, 2005, the disclosure of which is incorporated herein by reference.

### FIELD OF THE INVENTION

The present invention relates to a controller applied to an internal combustion engine having a supercharger such as a turbocharger and for suitably controlling assist power to the supercharger. More particularly, a controller of the present invention is directed to control a diesel engine that controls output torque of an internal combustion engine by adjusting a fuel injection amount.

### BACKGROUND OF THE INVENTION

JP-2002-21573A (U.S. Pat. No. 6,889,503B2) discloses a technique that an auxiliary compressor as an auxiliary supercharging device is provided for an intake path in order to improve supercharging response of a turbocharger. The auxiliary compressor is operated by, for example, an electric motor.

However, a control method of properly operating the auxiliary compressor with a proper control amount is not disclosed. In a configuration of operating an auxiliary compressor by an electric motor, the auxiliary compressor is unnecessarily operated and a power generation amount by an alternator or the like increases and, as a result, the fuel consumption may deteriorate. When the operation amount of the auxiliary compressor is insufficient, the supercharging performance (acceleration performance) intended by the driver cannot be obtained at the time of acceleration or the like, and drivability may deteriorate.

### SUMMARY OF THE INVENTION

An object of the present invention is to provide a controller for an internal combustion engine with a supercharger. The internal combustion engine includes a supercharger for performing supercharging with exhaust power and an auxiliary supercharging device using power other than exhaust power as a power source. In the internal combustion engine, the auxiliary supercharging device can be properly controlled and a high-precision boost pressure control can be performed.

The controller of the present invention is applied to an internal combustion engine having a supercharger for supercharging intake air by exhaust power and an auxiliary supercharging device provided on the upstream or downstream side of the supercharger in an intake path and operated by using power other than exhaust as a power source. In the internal combustion engine, by adjusting a fuel injection amount of fuel injection means, output torque of the internal combustion engine is controlled. In particular, target power and actual power of the supercharger are calculated. On the basis of the target power and the actual power, an assist amount of the auxiliary supercharging device is calculated. With the calculated assist amount, the auxiliary supercharging device is controlled. For example, the target and actual powers are compared with each other and an assist amount may be calculated on the basis of the power difference.

In short, by the comparison between the target power and the actual power of the supercharger, an insufficient amount of power with respect to the inherently-necessary supercharger power can be grasped, and the auxiliary supercharging device can be driven by an assist amount corresponding to the insufficient amount. For example, the difference between the target power and the actual power is obtained, and the auxiliary supercharging device is driven by an assist amount calculated on the basis of the power difference. In such a case, by setting the insufficient amount with respect to the target power as an assist amount, the supercharger power can be assisted efficiently without wasting it. Since the assist amount is calculated by comparison of the powers, assist control can be performed more directly with higher response as compared with the case of calculating the assist amount by using another parameter such as boost pressure. For example, the behavior of the boost pressure is a result of the assist control. In the case where the assist control is performed on the basis of the boost pressure, a delay occurs in the control. The present invention can prevent such an inconvenience. Consequently, the auxiliary supercharging device can be properly controlled. Moreover, high-precision boost pressure control can be realized.

### BRIEF DESCRIPTION OF THE DRAWING

FIG. 1 is a diagram showing a schematic configuration of an engine control system in an embodiment of the invention.

FIG. 2 is a control block diagram illustrating functions of an engine ECU.

FIG. 3 is a diagram for calculating a pressure loss amount.

FIG. 4 is a diagram for calculating a target compressor upstream pressure.

FIG. 5 is a diagram for calculating an assist power.

FIG. 6 is a control block diagram showing a turbo model.

FIG. 7 is a diagram showing a pressure loss model of an inter-cooler model.

FIG. 8 is a diagram showing a cooling effect model of the inter-cooler model.

FIG. 9 is a control block diagram showing the details of a target power calculating unit and an actual power calculating unit in an assist control unit.

FIG. 10 is a diagram showing the relation between boost pressure and supercharge temperature.

FIG. 11 is a diagram showing the relation between supercharging energy and compressor efficiency.

FIG. 12 is a flowchart showing a base routine performed by the engine ECU.

FIG. 13 is a flowchart showing a fuel injection amount calculating routine.

FIG. 14 is a flowchart showing an assist power calculating routine.

FIG. 15 is a flowchart showing a target compressor power calculating routine.

FIG. 16 is a flowchart showing an actual compressor power calculating routine.

FIG. 17 is a flowchart showing an assist determination routine.

FIG. 18 is a time chart showing various behaviors at the time of assist control in the embodiment.

### DETAILED DESCRIPTION OF EMBODIMENTS

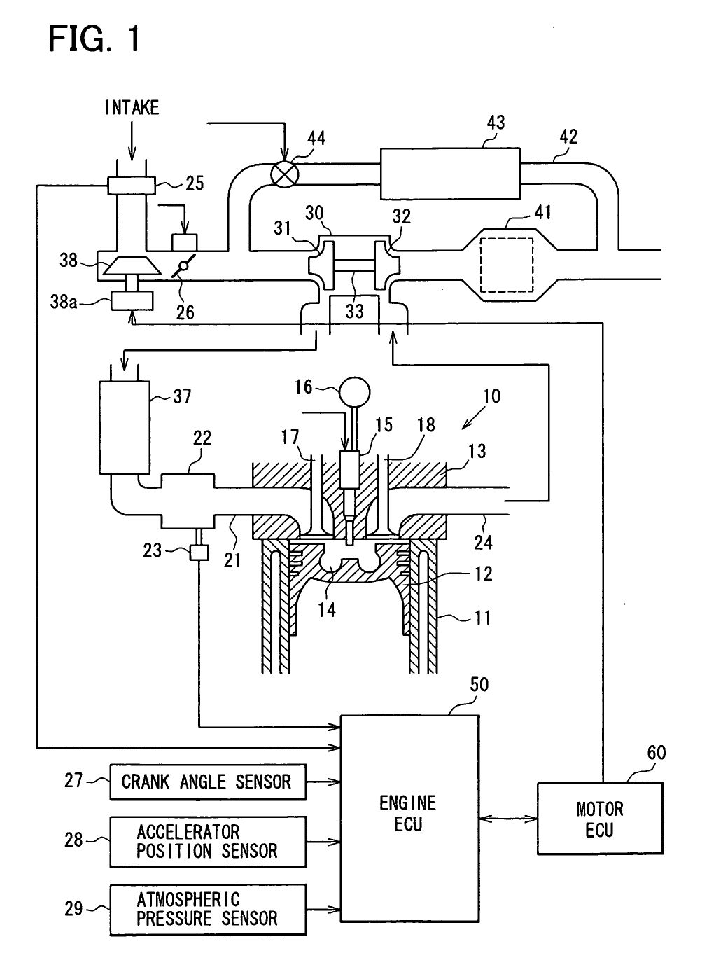

An embodiment of the present invention will be described below with reference to the drawings. In the embodiment, an engine control system is constructed for an on-vehicle multi-cylinder diesel engine as an internal combustion engine, a turbocharger as a supercharger is provided for the engine of the control system, and an auxiliary compressor as an auxiliary supercharging device is provided on the upstream side of the turbocharger. First, a general schematic configuration diagram of an engine control system will be described with reference to FIG. 1.

In an engine 10 shown in FIG. 1, a piston 12 is enclosed in a cylinder block 11, and a combustion chamber 14 is defined by the cylinder inner walls, the piston 12, and a cylinder head 13. In the cylinder head 13, an electrically controlled fuel injection valve 15 is disposed. A high-pressure fuel is supplied from a common rail 16 to the fuel injection valve 15, and the fuel is injected into the combustion chamber 14 by an opening operation of the fuel injection valve 15. Although not shown, the system has a fuel pump for pressure-feeding the fuel in a fuel tank to the common rail 16. A fuel discharge amount of the fuel pump is controlled on the basis of a pressure (fuel pressure) in the common rail detected by a sensor or the like.

An intake valve 17 is disposed for an intake port, and an exhaust valve 18 is disposed for an exhaust port. An intake pipe 21 is connected to the intake port, and an inter-cooler 37 is disposed on the upstream side of a surge tank 22 in the intake pipe 221. For the surge tank 22, an intake pressure sensor 23 for detecting intake pipe pressure (which is also boost pressure of a turbocharger which will be described later) is provided. An exhaust pipe 24 is connected to an exhaust port.

A turbocharger 30 is disposed between the intake pipe 21 and the exhaust pipe 24. The turbocharger 30 has a compressor impeller 31 provided for the intake pipe 21 and a turbine wheel 32 provided for the exhaust pipe 24. The compressor impeller 31 and the turbine wheel 32 are coupled to each other via a shaft 33. In the turbocharger 30, the turbine wheel 32 is rotated by exhaust flowing in the exhaust pipe 24. The rotational force is transmitted to the compressor impeller 31 via the shaft 33. By the compressor impeller 31, intake air flowing in the intake pipe 21 is compressed and supercharging is performed. The air supercharged in the turbocharger 30 is cooled by the inter-cooler 37 and, after that, the cooled air is supplied to the downstream side. By cooling the intake air by the inter-cooler 37, the intake air charging efficiency is increased.

An electrically driven auxiliary compressor 38 is provided on the compressor upstream side of the turbocharger 30 in the intake pipe 21. The intake air is compressed upstream of the turbocharger 30 by the auxiliary compressor 38. The auxiliary compressor 38 uses a motor 38a as a drive source. When the motor 38a is driven by power supply from a battery (not shown), the auxiliary compressor 38 operates. That is, the auxiliary compressor 38 uses, as a power source, power other than exhaust different from the turbocharger 30.

A not-shown air cleaner is provided in the uppermost part of the intake pipe 21. On the downstream side of the air cleaner, an air flow meter 25 for detecting an intake air volume and a throttle valve 26 driven by a step motor are provided. In addition, the control system has various sensors such as a crank angle sensor 27 for outputting a rectangular-shaped crank angle signal every predetermined crank angle (for example, every 30° C.A) with rotation of the engine 10, an accelerator position sensor 28 for detecting a stroke amount of the acceleration pedal (accelerator position), and an atmospheric pressure sensor 29 for detecting an atmospheric pressure.

A catalyst device 41 having therein a NOx absorbent is provided on the turbine downstream side of the turbocharger 30 in the exhaust pipe 24. Further, an EGR path 42 is provided between the compressor upstream side of the turbocharger 30 in the intake pipe 21 and the downstream side of the catalyst device 41 in the exhaust pipe 24. In midpoints of the EGR path 42, an EGR inter-cooler 43 for cooling EGR gas by engine cooling water or the like and an EGR control valve 44 driven by a step motor are disposed.

An engine ECU (Electronic Control Unit) 50 is constructed, as it is known, by using a microcomputer as a main body including a CPU, a ROM, and a RAM. By executing various control programs stored in the ROM, the engine ECU 50 executes various controls on the engine 10 in accordance with the engine operating state. Specifically, various detection signals are input to the engine ECU 50 from the various sensors described above. The engine ECU 50 computes a fuel injection amount, a throttle valve control amount, an EGR control amount, a fuel pressure control amount, and the like on the basis of the various detection signals which are input. On the basis of the computed amounts, the engine ECU 50 controls the driving of the fuel injection valve 15, throttle valve 26, EGR control valve 44, a fuel pump, and the like.

In the embodiment, fuel injection amount control by so-called torque base control is executed to control the fuel injection amount to a target value by using torque generated in the engine 10 as a reference. Briefly, the engine ECU 50 computes target torque (required torque) on the basis of a detection signal of the accelerator position sensor 28, computes a target fuel injection amount satisfying the target torque, and controls driving of the fuel injection valve 15 in response to a control instruction signal based on the target fuel injection amount.

The engine ECU 50 determines an amount of control on the auxiliary compressor 38 (motor 38a) interlockingly with the torque base control so that assist power is added to the turbocharger 30 at the time of acceleration and desired boost pressure can be obtained as promptly as possible. Specifically, the engine ECU 50 computes target assist power, power assist timing, and the like on the basis of the target fuel injection amount and the target boost pressure calculated according to the target torque, and outputs the computation results to a motor ECU 60. The motor ECU 60 receives a signal from the engine ECU 50, performs predetermined computing process in consideration of the motor efficiency and the like, and controls the power to be supplied to the motor 38a of the auxiliary compressor 38.

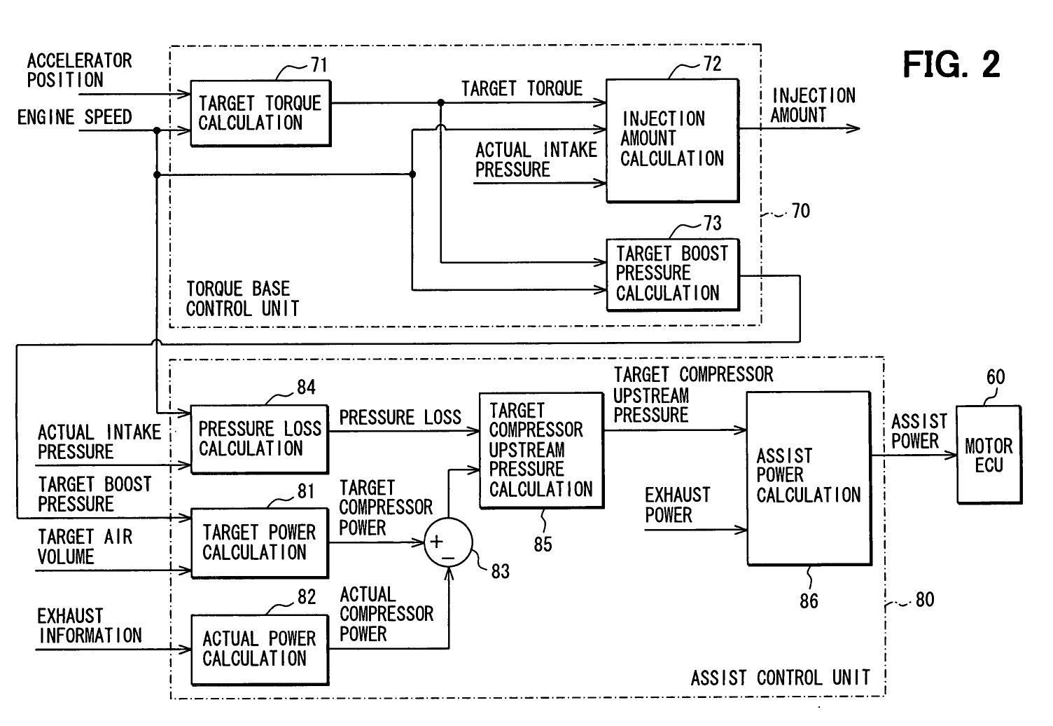

Next, the outline of the control of the engine ECU 50 in the embodiment will be described with reference to FIG. 2.

The system shown in FIG. 2 has, as main functions, a torque base control unit 70 for calculating a target fuel injection amount on the basis of the target torque requested by the driver and an assist control unit 80 for calculating the assist power of the auxiliary compressor 38 (motor 38a) to be instructed to the motor ECU 60. The details of the control units 70 and 80 will be described below.

In the torque base control unit 70, a target torque calculating unit 71 calculates target torque on the basis of the accelerator position and the engine speed. An injection amount calculating unit 72 calculates a target fuel injection amount on the basis of the target torque and the engine speed, and also calculates a final injection amount by properly performing smoke guard, fuel pressure correction, or the like on the target fuel injection amount. In this case, a smoke guard (the upper limit value for setting a smoke generation amount to be within a permissible range) is set on the basis of the actual intake air pressure and the like. By the smoke guard, the upper limit of the target fuel injection amount is guarded, and a final fuel injection amount is determined. The higher the actual intake air pressure is, the larger the smoke guard is set. By the setting of the smoke guard, the target torque can be realized while suppressing generation of smokes. The actual intake pressure is intake pressure detected by the intake pressure sensor 23 (boost pressure generated by the turbocharger). The target fuel injection amount calculated on the basis of the target torque and the engine speed corresponds to a fuel amount required to realize target torque requested by the driver.

A target boost pressure calculating unit 73 calculates target boost pressure on the basis of the target torque and the engine speed.

In the assist control unit 80, a target power calculating unit 81 calculates target compressor power on the basis of a target air volume calculated from a map or the like and the target boost pressure calculated by the torque base control unit 70. The target air volume is calculated in accordance with the target boost pressure on the basis of the air volume actually measured by the air flow meter 25. In place of the map computation, the target air volume can be also calculated by estimation using a model. An actual power calculating unit 82 calculates actual compressor power on the basis of exhaust information. A power difference calculating unit 83 calculates the power difference between the target compressor power and the actual compressor power.

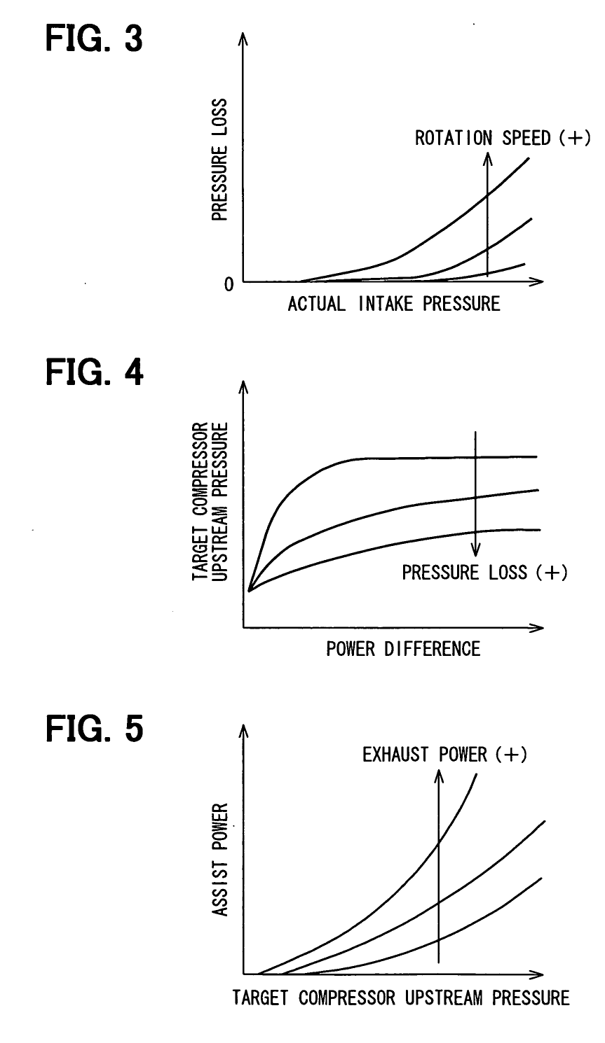

A pressure loss calculating unit 84 calculates an amount of pressure loss which occurs in the upstream part of the intake pipe such as an air cleaner, the auxiliary compressor 38, and the like on the basis of the engine speed and an actual intake pressure. At this time, the pressure loss amount is calculated by using, for example, the relation shown in FIG. 3. The higher the actual intake pressure or the engine speed is, the larger the pressure loss amount is calculated.

A target compressor upstream pressure calculating unit 85 calculates target compressor upstream pressure on the basis of the power difference calculated by the power difference calculating unit 83 and the pressure loss amount calculated by the pressure loss calculating unit 84. The target compressor upstream pressure is target pressure (target compressor input pressure) at the inlet of the compressor impeller 31 of the turbocharger 30 and is calculated by using, for example, the relation shown in FIG. 4. The larger the power difference is, the larger the target compressor upstream pressure is calculated. The larger the pressure loss amount is, the lower the target compressor upstream pressure is calculated.

An assist power calculating unit 86 calculates assist power on the basis of the calculated target compressor upstream pressure and an exhaust power and outputs the assist power (motor instruction value) to the motor ECU 60. In this case, the assist power is calculated by using the relation shown in FIG. 5. The higher the target compressor upstream pressure is or the higher the exhaust power is, the higher the assist power calculated is. The exhaust power is calculated on the basis of exhaust characteristics such as exhaust flow rate, exhaust pressure, and exhaust temperature.

The assist power of the auxiliary compressor 38 is calculated as an insufficient amount of the actual compressor power for the target compressor power. That is, the compressor power insufficient amount is compensated by the power assist of the auxiliary compressor 38. The assist control unit 80 also calculates an assist amount in power by using power as a unification parameter. Since an instruction value of the motor ECU 60 of a turbo system is a motor output, it is preferable to calculate the assist amount in power.

At the time of calculating the assist power, it is desirable to correct the assist power and set an upper limit guard on the basis of the performance and the operation state of the motor 38a, the engine operating state, and the like. In the embodiment, the upper limit value of the assist power is set by using the motor temperature as a parameter and, by the upper limit value, the upper limit of the assist power is set.

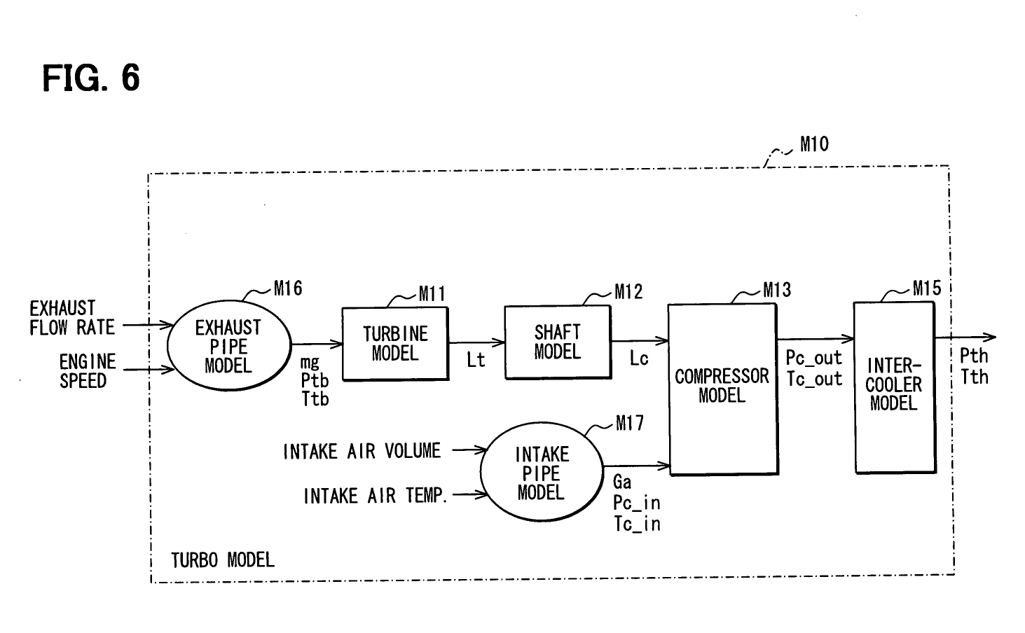

In the embodiment, the compressor powers (the target compressor power and the actual compressor power) are calculated in the assist control unit 80 by using a turbo model. The details will be described below. FIG. 6 is a control block diagram showing a turbo model M10. The turbo model also includes the inter-cooler 37 provided with the turbocharger 30.

In FIG. 6, the turbine wheel 32, shaft 33, compressor impeller 31, and inter-cooler 37 are modeled as a turbine model M11, a shaft model M12, a compressor model M13, and an inter-cooler model M15, respectively. In addition to the parts models of the turbocharger, an exhaust pipe model M16 in which delay of exhaust and the like is considered and an intake pipe model M17 in which delay of intake and the like is considered are provided.

In the turbo model M10, the turbine model M11, the shaft model M12, and the compressor model M13 are configured by using the flow of energy (power) as a unification parameter on the basis of the principle of supercharging, thereby increasing the convenience (reusability) at the time of reusing the models. In other words, the model once configured can be easily applied to another system. On the basis of the model, modeling of an electronized supercharger having high redundancy can be easily performed, and a model with high general versatility can be realized.

In the turbine model M11, turbine power Lt is calculated by using Equation (1) from exhaust parameters (exhaust flow rate mg, turbine upstream pressure Ptb_in, turbine downstream pressure Ptb_out, turbine upstream temperature Ttb_in, and turbine adiabatic efficiency ηg) of the engine 10 calculated in the exhaust pipe model M16.

$${L}_{t} = {c}_{g} {T}_{tb\_in} \{ 1 - {( \frac{{P}_{tb\_in}}{{P}_{tb\_out}} )}^{\frac{{κ}_{g} - 1}{{κ}_{g}}} \} {m}_{g} {η}_{g} \qquad ( 1 )$$

where ηg denotes specific heat of exhaust, and κg denotes ratio of the specific heat. The turbine power Lt obtained by the equation (1) is input to the following shaft model M12.

The temperature, pressure, and flow rate as the exhaust parameters of the engine 10 may be actual measurement values of sensors or the like or estimated values obtained by using models or maps. In the embodiment, the exhaust flow rate mg is calculated from an actual measurement value of the air flow meter 25 and an injection signal (or air fuel ratio). The turbine upstream/downstream pressures Ptb and the turbine upstream/downstream temperatures Ttb are calculated from the exhaust flow rate mg by using a table which is preliminarily generated.

In an actual turbo system, many delay elements exist. For example, in the configuration of calculating the exhaust flow rate mg on the basis of the actual measurement value of the air flow meter 25, a delay occurs in actual reflection of the measured intake air volume into the exhaust flow rate in the turbine. Consequently, in the exhaust pipe model M16, the exhaust flow rate mg is calculated in consideration of delay elements and the like due to the volume of the exhaust pipe 24 (the exhaust pipe volume from the export port to the turbine), pressure, and engine speed.

In the shaft model M12, the turbine power Lt is converted to compressor power Lc by Equation (2) and the compressor power Lc is output. ηt denotes power conversion efficiency.
L_{c=ηt}L_{tc} (2)

The compressor power Lc derived by Equation (2) is input to the compressor model M13.

In the compressor model M13, boost pressure energy is calculated from the compressor power Lc and compressor efficiency ηc (Equation (3)). By modifying Equation (3), Equation (4) is obtained. A compressor downstream pressure (output pressure) Pc_out is calculated by using the boost pressure energy calculation value and intake parameters (intake air volume Ga, compressor upstream pressure (input pressure) Pc_in, and intake air temperature Tc_in) (Equation 4). In Equation (4), ca denotes the specific heat of intake air, and κa denotes the ratio of specific heat. The intake air volume Ga is calculated from a detection signal of the air flow meter 25. The compressor upstream pressure Pc_in is calculated from a detection signal of the atmospheric pressure sensor 29. The intake air temperature Tc_in is calculated from a detection signal of an intake air temperature sensor (for example, a temperature sensor attached to the air flow meter).

$$\begin{matrix}{L}_{c} {η}_{c} = {c}_{a} {T}_{c\_in} \{ {( \frac{{P}_{c\_out}}{{P}_{c\_in}} )}^{\frac{{κ}_{a} - 1}{{κ}_{a}}} - 1 \} {G}_{a} & ( 3 ) \\ {P}_{c\_out} = {{P}_{c\_in} ( 1 + \frac{{L}_{c} {η}_{c}}{{c}_{a} {T}_{c\_in} {G}_{a}} )}^{\frac{{κ}_{a}}{{κ}_{a} - 1}} & ( 4 )\end{matrix}$$

The air volume and pressure as intake air parameters of the engine 10 are calculated as values in which transport delay and the like caused by volume of the intake pipe 11 (volume of the intake pipe extending from the compressor to the throttle), pressure, and the like in the intake pipe model M17 are considered.

Each of the efficiencies used in Equations (1) to (3) is obtained from a table of power (energy) of an input or by calculation. The efficiencies ηg and ηc can be computed by using adiabatic efficiency obtained from temperature and pressure. An efficiency ηt of power conversion from the turbine power Lt to the compressor power Lc is determined by obtaining each adiabatic efficiency and, after that, at the time of identifying a model, obtaining Lc/Lt from energy actually necessary for supercharging and the turbine power Lt at that time. By using an inverse-model method, a model can be generated without knowledge of conversion efficiency (machine efficiency or the like) of an actual turbo charger, and a stationary value of an actual machine can be reproduced by a model.

The compressor efficiency ηc is expressed as Equation (5).

$${η}_{c} = \frac{{T}_{c\_in} \{ {( \frac{{P}_{c\_out}}{{P}_{c\_in}} )}^{\frac{κ - 1}{κ}} - 1 \}}{{T}_{c\_out} - {T}_{c\_in}} \qquad ( 5 )$$

Equation (5) can be modified as the following equation (6). When the compressor efficiency ηc, compressor upstream pressure Pc_in, compressor downstream pressure Pc_out, and intake air temperature Tc_in are known, the compressor downstream temperature Tc_out can be calculated from Equation (6).

$${T}_{c\_out} = {T}_{c\_in} + \frac{{T}_{c\_in}}{{η}_{c}} \{ {( \frac{{P}_{c\_out}}{{P}_{c\_in}} )}^{\frac{κ - 1}{κ}} - 1 \} \qquad ( 6 )$$

By the above flow, the compressor downstream pressure Pc_out and the compressor downstream temperature Tc_out are calculated and are input to the inter-cooler model M15 at the next stage.

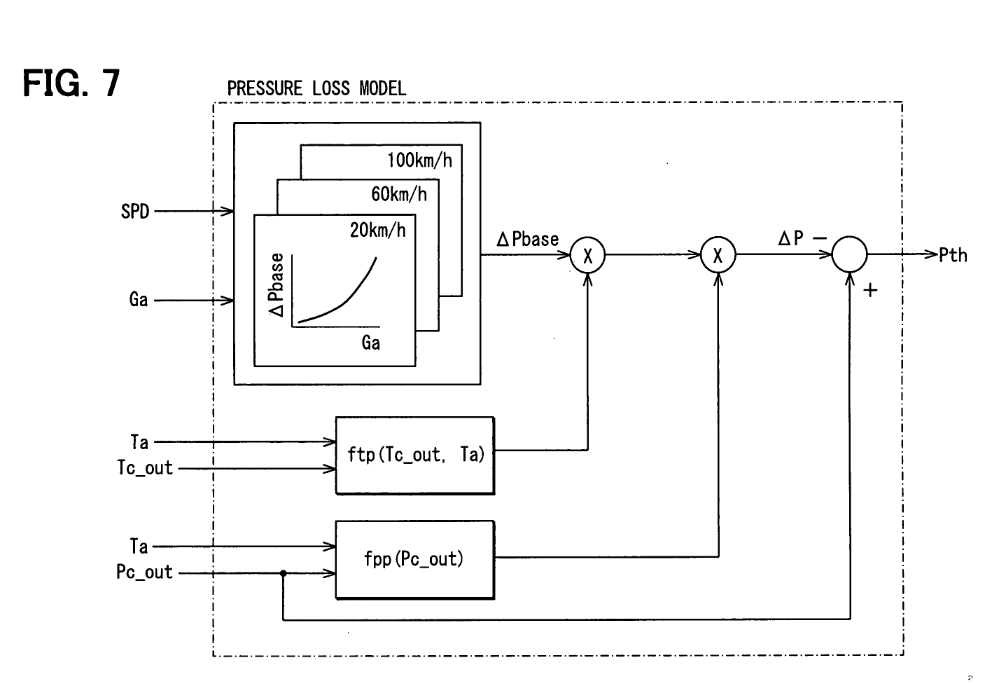

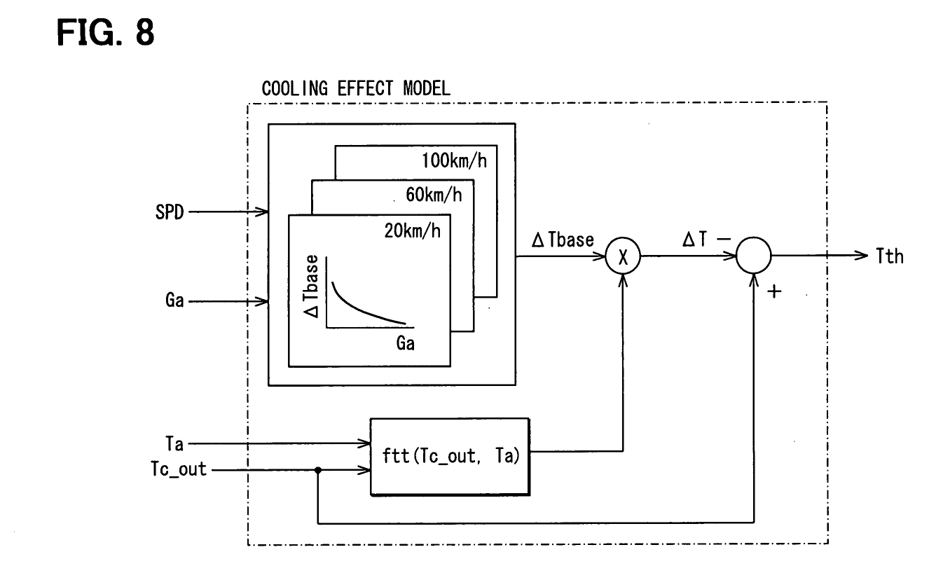

The inter-cooler model M15 is divided in a pressure loss model part for calculating pressure loss in the inter-cooler 37 and a cooling effect model part for calculating a cooling effect (temperature drop). The configuration of the former part is shown in FIG. 7. The configuration of the latter part is shown in FIG. 8. The pressure loss and the cooling effect are configured on the basis of the unit characteristic of the inter-cooler. The unit characteristic is specified as follows.

First, outside air temperature Ta_base, atmospheric air pressure Pa_base, compressor downstream pressure Pb_base, and compressor downstream temperature Tb_base as references are determined. The values are arbitrarily-determined reference operational condition values in an engine with a turbocharger to configure a model. Under the reference operational conditions, pressure loss ΔP as a pressure loss characteristic and a temperature drop amount ΔT as a cooling effect characteristic (temperature drop characteristic) with respect to an inter-cooler inflow rate are obtained. The pressure loss ΔP is the difference between an input pressure and an output pressure of the intercooler. The temperature drop amount ΔT is the difference between an input temperature and an output temperature of the inter-cooler. This is a reference model.

The pressure loss and the cooling effect in the inter-cooler 37 change with parameters of the intercooler input pressure (compressor downstream pressure Pc_out), temperature (compressor downstream temperature Tc_out), outside air temperature Ta, and velocity of wind passing through the inter-cooler 37 (that is, vehicle speed). Consequently, on the basis of each of the parameters, the calculation value is corrected under the reference conditions. In this case, the pressure loss decreases with rise in the compressor downstream pressure Pc_out or the compressor downstream temperature Tc_out, or increase in the wind velocity. The cooling effect (temperature drop) increases with rise in the compressor downstream temperature Tc_out or increase in the wind velocity.

In the pressure loss model shown in FIG. 7, with a characteristic map generated by setting the outside air temperature Ta_base, the compressor downstream temperature Pb_base, and the compressor downstream temperature Tb_base as reference values (for example, Ta_base=25° C., Pb_base=0 kPa, and Tb_base=75° C.), a reference pressure loss ΔPbase is calculated on the basis of the intake air volume Ga and the vehicle speed SPD at each time.

A compression correction factor is calculated on the basis of the compressor downstream pressure Pc_out by using Equation (7), and a temperature correction factor is calculated on the basis of the compressor downstream temperature Tc_out and the outside air temperature Ta by using Equation (8). ρ(T) denotes density of air at an arbitrary temperature.

$$\begin{matrix}{f}_{pp} ( {P}_{c\_out} ) = \frac{{P}_{a\_base}}{{P}_{a\_base} + {P}_{c\_out}} & ( 7 ) \\ {f}_{tp} ( {T}_{c\_out} , {T}_{a} ) = \frac{ρ ( {T}_{b\_base} - {T}_{a\_base} )}{ρ ( {T}_{c\_out} - {T}_{a} )} & ( 8 )\end{matrix}$$

The temperature correction by Equation (8) is performed in consideration of the influence of the difference between the outside air temperature and supercharge temperature, and the temperature correction accompanying a change in the outside air temperature Ta is included in Equation (8) (temperature correction by Equation (10) which will be described later is similarly performed).

After that, boost pressure Pth (inter-cooler downstream pressure) is calculated by the following equation (9).
Pₜₕ=P_{c}_{_{—}}ₒᵤₜ−ΔP_{base}×fₜₚ(T_{c}_{_{—}}ₒᵤₜ, Tₐ)×fₚₚ(P_{c}_{_{—}}ₒᵤₜ) (9)

In the cooling effect model shown FIG. 8, like the pressure loss model of FIG. 7, a reference temperature drop amount ΔTbase is calculated on the basis of the intake air volume Ga and the vehicle speed SPD at each time by using a characteristic map generated by setting the outside air temperature Ta_base, the compressor downstream pressure Pb_base, and the compressor downstream temperature Tb_base as reference values (for example, Ta_base=25° C., Pb_base=0 kPa, and Tb_base=75° C.).

By using Equation (10), a temperature correction factor is calculated on the basis of the compressor downstream temperature Tc_out and the outside air temperature Ta.

$${f}_{tt} ( {T}_{c\_out} , {T}_{a} ) = \frac{{T}_{c\_out} - {T}_{a}}{{T}_{b\_base} - {T}_{a\_base}} \qquad ( 10 )$$

As described above, even when the compressor downstream pressure Pc_out changes, mass flow to the inter-cooler 37 does not change, so that the pressure correction for the cooling effect (temperature drop) is not performed.

By the following equation (11), a supercharge temperature Tth (inter-cooler downstream temperature) is calculated.
Tₜₕ=T_{c}_{_{—}}ₒᵤₜ−ΔT_{base}×fₜₜ(T_{c}_{_{—}}ₒᵤₜ,Tₐ) (11)

In such a manner, the boost pressure Pth and the supercharge temperature Tth as outputs of the inter-cooler model M15 are calculated.

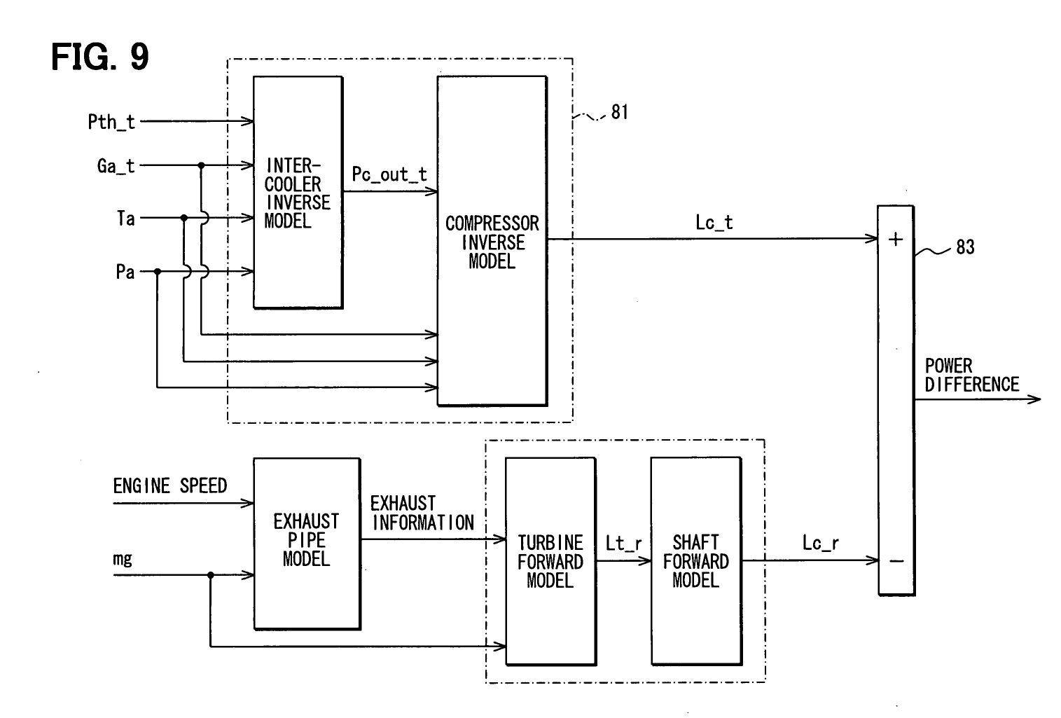

The target power calculating unit 81 and the actual power calculating unit 82 in the assist control unit 80 of FIG. 2 are configured on the basis of the turbo model M10, and the outline of the units 81 and 82 is shown as a control block diagram of FIG. 9. The target power calculating unit 81 calculates target compressor power Lc_t by inverse calculation (inverse model) of the turbo model M10. The actual power calculating unit 82 calculates actual compressor power Lc_r by forward calculation (forward model) of the turbo model M10.

In short, the target power calculating unit 81 calculates the target compressor power Lc_t by using the inverse models of the compressor model M13 and the inter-cooler model M15 in FIG. 4 and using the target boost pressure Pth_t and the target air volume Ga_t as main computation parameters. In this case, specifically, in the inter-cooler inverse model, by using a map (FIG. 10) based on actual machine data, the target supercharge temperature Tth_t is calculated on the basis of the target boost pressure Pth_t. By making a back calculation expression with the inverse model (of the pressure loss model of the inter-cooler) of FIG. 7 and the inverse model (of the cooling effect model) of FIG. 8, target compressor downstream pressure Pc_out_t is calculated on the basis of the target boost pressure Pth_t, the target supercharge temperature Tth_t and, in addition, the target air volume Ga_t, the outside air temperature Ta (compressor upstream temperature), and the atmospheric pressure Pa (compressor upstream pressure).

In the inverse model of the compressor, a target supercharge energy Wc_t is calculated by using the following equation (12) from the target compressor downstream pressure Pc_out_t, target air volume Ga_t, outside air temperature Ta, and atmospheric air pressure Pa. In the equation, ca denotes specific heat of air, and κa denotes the ratio of specific heat of air.

$${W}_{c\_t} = {c}_{a} {T}_{a} \{ {( \frac{{P}_{c\_out \_t}}{{P}_{a}} )}^{\frac{{κ}_{a} - 1}{{κ}_{a}}} - 1 \} {G}_{a\_t} \qquad ( 12 )$$

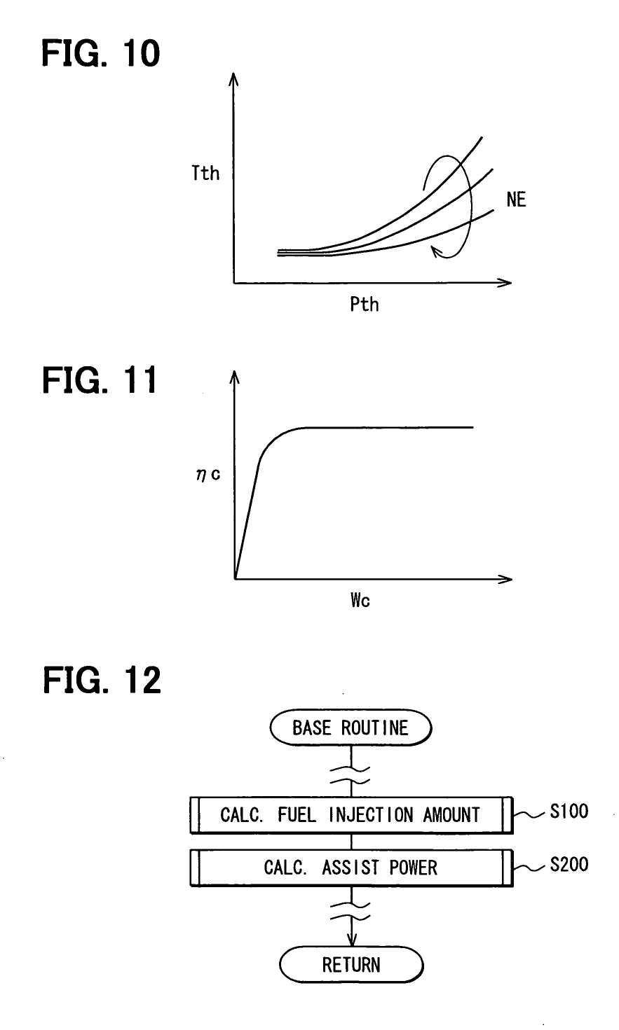

Further, compressor efficiency ηc_t is calculated from the efficiency map shown in FIG. 11 using the target supercharge energy Wc_t as a parameter and the target compressor power Lc_t is calculated by the following equation (13).
L_{c}_{_{—}}ₜ=W_{c}_{_{—}}ₜ/η_{c}_{_{—}}ₜ (13)

The actual power calculating unit 82 calculates the actual compressor power. Lc_r by exhaust via an exhaust pipe model, a turbine model (forward model), and a shaft model (forward model) in a manner similar to the calculation order of the turbo model. That is, the actual turbine power Lt_r is calculated by using the equation (1) from the exhaust parameters (exhaust flow rate mg, turbine upstream pressure Ptb_in, turbine downstream pressure Ptb_out, turbine upstream temperature Ttb_in, and turbine adiabatic efficiency ηg) of the engine 10 calculated in the exhaust pipe model. Further, by multiplying the actual turbine power Lt_r with power conversion efficiency ηt, the actual compressor power Lc_r is calculated.

The power difference calculating unit 83 calculates the power difference (=Lc_t−Lc_r) between the target compressor power Lc_t and the actual compressor power Lc_r calculated as described above. In the target compressor upstream pressure calculating unit 85 and the assist power calculating unit 86 (see FIG. 2) at the post stage, on the basis of the power difference, target compressor upstream pressure and, further, a request assist power are calculated. After that, an assist power signal (motor instruction value) is output to the motor ECU 60.

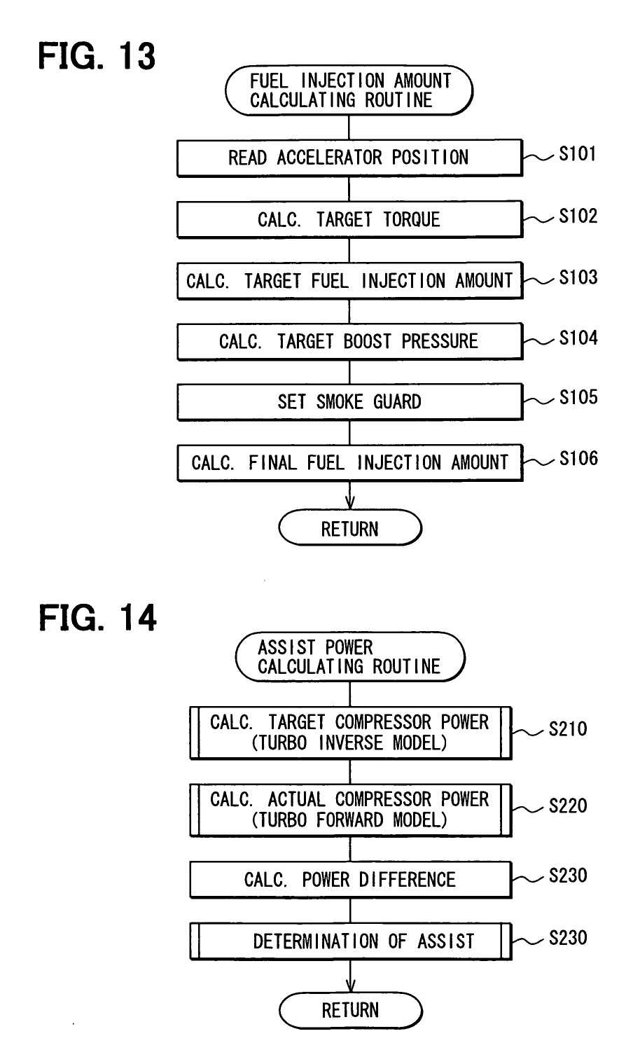

Next, the flow of process of calculating the fuel injection amount and the assist power by the engine ECU 50 will be described with reference to the flowcharts of FIGS. 12 to 17. FIG. 12 is a flowchart showing a base routine. The routine is executed, for example, every 4 msec by the engine ECU 50. In the base routine of FIG. 12, sub routines of FIGS. 13 to 17 are properly executed. The flow of the processes described below is basically according to the control block diagram of FIG. 2 and repetitive description will be partly omitted.

As shown in FIG. 12, the base routine includes a fuel injection amount calculating routine (Step S100) and an assist power calculating routine (Step S200). FIG. 13 shows the details of the fuel injection amount calculating routine, and FIG. 14 shows the details of the assist power calculating routine.

In the fuel injection amount calculating routine shown in FIG. 13, first, an accelerator position detection value is read (Step S101). Next, a target torque is calculated on the basis of the accelerator position and the engine speed (Step S102). A target fuel injection amount and a target boost pressure are calculated on the basis of the target torque and the engine speed (Steps S103 and S104). After that, a smoke guard is set on the basis of an actual intake pressure (actual boost pressure), fuel pressure, and the other engine operating state (Step S105). Finally, a final injection amount is calculated by using the smoke guard as the upper limit value (Step S106).

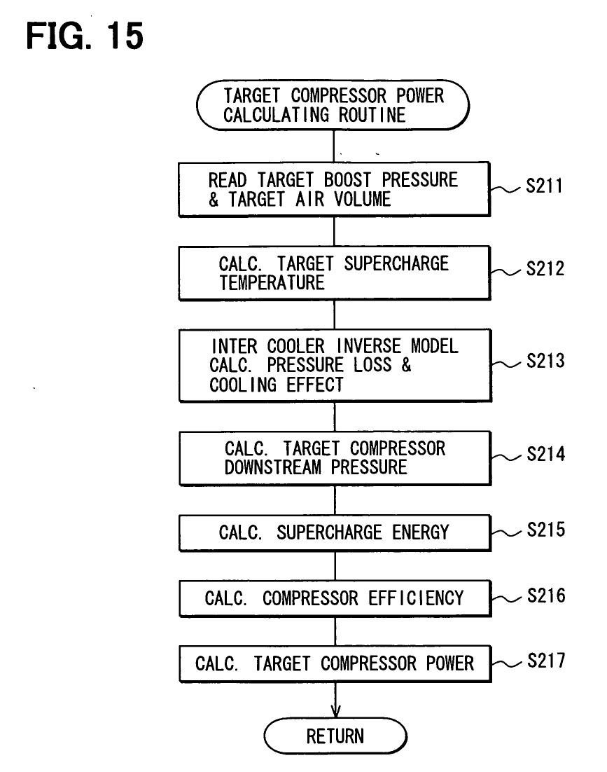

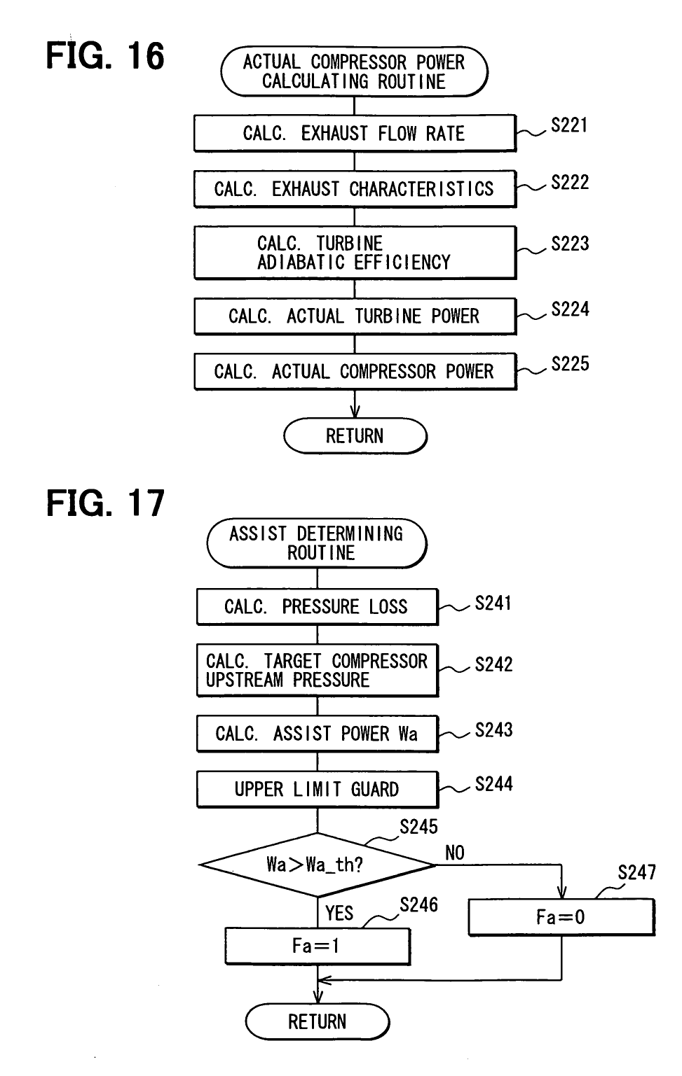

In the assist power calculating routine shown in FIG. 14, first, by using the subroutine of FIG. 15 which will be described later, the target compressor power is calculated on the basis of the inverse model of the turbo model (Step S210). Next, by using the subroutine of FIG. 16 which will be described later, an actual compressor power is calculated on the basis of the forward model of the turbo model (Step S220). By subtracting the actual compressor power from the target compressor power, the power difference is calculated (Step S230). By using the subroutine of FIG. 17 which will be described later, whether the power assist can be performed or not is determined (Step S240).

In the target turbine power calculating subroutine shown in FIG. 15, the target boost pressure and the target air volume are read (Step S211). Subsequently, for example, by using the relation of FIG. 10, the target supercharge temperature is calculated on the basis of the target boost pressure (Step S212). After that, by using the inverse model of the inter-cooler, the target compressor downstream pressure is calculated while considering the pressure loss and the cooling effect in the inter-cooler (Steps S213 and S214). The target supercharge energy is calculated by using the inverse model of the compressor, and the compressor efficiency is calculated by using, for example, the relation of FIG. 11 (Steps S215 and S216). The target compressor power is calculated from the target supercharge energy and the compressor efficiency (Step S217).

The actual compressor power calculating subroutine shown in FIG. 16 is constructed by an exhaust pipe model part, a turbine model part, and a shaft model part. In the exhaust pipe model part, the exhaust flow rate is calculated in consideration of a delay which occurs in reflection of an air volume measured by the air flow meter 25 as the exhaust flow rate into the turbine (Step S221). On the basis of the exhaust flow rate, exhaust characteristics (pressures and temperatures on the upstream/downstream sides of the turbine) are calculated (Step S222). The turbine model part calculates the turbine adiabatic efficiency ηg (Step S223) and calculates the actual turbine power on the basis of the exhaust parameters such as the exhaust flow rate, exhaust pressure, and exhaust temperature and the turbine adiabatic efficiency ηg (Step S224). Further, in the shaft model part, the actual compressor power is calculated on the basis of the actual turbine power and the power conversion efficiency (Step S225).

In the assist determining routine shown in FIG. 17, an amount of a pressure loss which occurs in the intake pipe upstream part such as an air cleaner is calculated by using the relation of FIG. 3 (Step S241). Subsequently, the target compressor upstream pressure is calculated on the basis of the deviation (power difference) of the compressor power and the pressure loss amount by using the relation of FIG. 4 (Step S242). The assist power Wa is calculated on the basis of the target compressor upstream pressure and exhaust power by using the relation of FIG. 5 (Step S243). Further, the upper limit guard based on the motor characteristics and the motor temperature is properly set for the assist power Wa (Step S244).

After that, whether the assist power Wa is larger than a predetermined value Wa_th or not is determined (Step S245). When Wa>Wa_th, 1 is set for an assist permit flag Fa. When Wa≦Wa_th, 0 is set for the assist permit flag Fa (Steps S246 and S247). By the operation, in the case where Wa>Wa_th (the assist permit flag Fa=1), the power assist by the motor 38a of the auxiliary compressor 38 is executed. In the case where Wa≦Wa_th (assist permit flag Fa=0), the power assist by the motor 38a is stopped.

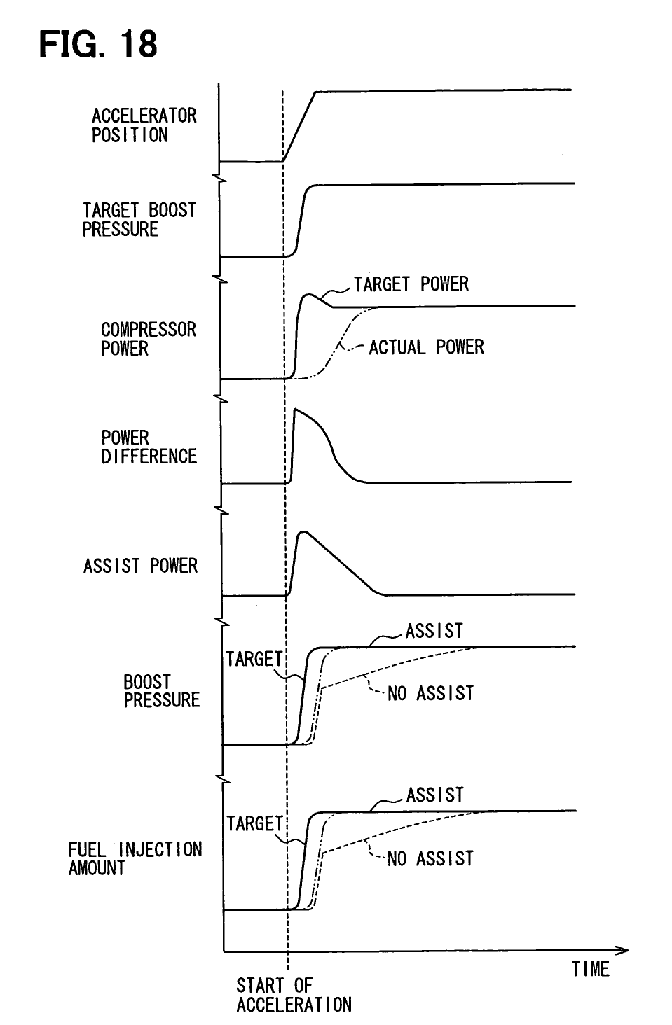

FIG. 18 is a time chart showing various behaviors in the case of using the assist control in the embodiment. When the accelerator position changes and acceleration starts, the target torque increases in accordance with an acceleration request and, in association with the increase, the target boost pressure increases. The target compressor power increases, and the actual compressor power increases after the target compressor power. In such a case, the power difference between the target compressor power and the actual compressor power is calculated. On the basis of the power difference, the assist power of the auxiliary compressor 38 (motor 38a) is calculated. By performing the assist control in such a manner, the actual boost pressure increases so as to trace the target value, and improvement in acceleration performance is realized.

At the time of acceleration, the target fuel injection amount increases as the target torque increases, and the actual fuel injection amount increases while being limited by the “smoke guard” (injection amount upper limit). Since the actual boost pressure rises quickly, the smoke guard increases first, and the fuel injection amount also increases promptly. Therefore, the target torque requested by the driver can be obtained promptly and reliably.

After that, when the actual compressor power increases sufficiently with respect to the target compressor power, the assist power is set to zero. In FIG. 18, the behavior of the actual boost pressure in the case where no power assist is given is shown by the broken line. It is understood that increase in the actual boost pressure lags largely. Due to the lag of the rise in the actual boost pressure, the limit of the fuel injection amount by the smoke guard increases. It delays increase in the fuel injection amount, and drivability deteriorates.

At the time of increase in the boost pressure, the actual boost pressure increases so as to follow the target value as promptly as possible irrespective of the presence/absence of the power assist until it reaches a reference pressure (atmospheric pressure). After that, the boost pressure increase ratio largely varies according to whether there is the power assist or not.

By the embodiment described above in detail, the following excellent effects are obtained.

The assist power is calculated on the basis of the power difference between the target compressor power and the actual compressor power in the turbocharger 30, and the power assist of the auxiliary compressor 38 (motor 38a) is controlled by the calculated assist power. Consequently, by using an insufficient amount for the target compressor power as an assist amount, wasteless, efficient assist control can be executed. Since the assist power is calculated by comparison of the powers, assist control can be performed more directly with higher response as compared with the case of calculating the assist power by using other parameters such as boost pressure. Thus, the power assist by the auxiliary compressor 38 provided on the compressor upstream side of the turbocharger 30 can be properly controlled and, moreover, fuel consumption, drivability, and the like can be improved.

Since responsiveness of the actual boost pressure is improved by controlling the power assist, the limit (smoke guard) of the fuel injection amount which is set on the basis of the actual boost pressure is relaxed and the fuel amount can be increased in accordance with an acceleration request or the like. Therefore, acceleration responsiveness to an acceleration request can be made excellent.

In particular, the target compressor upstream pressure (the target pressure between the auxiliary compressor 38 and the compressor impeller 31) is calculated on the basis of the power difference between the target compressor power and the actual compressor power, and the assist power is calculated on the basis of the calculated target compressor upstream pressure. Consequently, the upstream pressure (compressor input pressure) of the compressor impeller 31 can be controlled to a pressure adapted to the power difference. Thus, proper power assist which is not excessive or insufficient can be realized.

In the configuration of executing the engine torque control (fuel injection amount control) on the basis of the target fuel injection amount calculated from the target torque, the target turbine power is calculated on the basis of the target air volume calculated by the target torque in a manner similar to the target fuel injection amount. Consequently, the fuel injection valve 15 (fuel injection means) and the auxiliary compressor 38 (auxiliary supercharging device) are controlled interlockingly, and precision of the torque control improves. Therefore, an engine output is prevented from becoming excessive or insufficient and drivability and the like can be further improved.

By using the electric turbo model M10 as a physical model expressing the flow of power in the turbocharger 30, the target turbine power is calculated by the inverse model of the turbo model (inverse models of the inter-cooler, the compressor, and the shaft), and the actual turbine power is calculated by the forward models of the turbo models (forward model of the turbine). Thus, the target turbine power and the actual turbine power can be calculated with high precision, and the precision of the power assist control can be improved.

By using the auxiliary compressor 38 separated from the turbocharger 30 as the auxiliary supercharging device, without forcing an existing turbo system to be largely modified or re-adapted, a preferable power assist supercharging system can be configured.

The present invention is not limited to the description of the foregoing embodiment and may be carried out as follows.

An auxiliary compressor (auxiliary supercharging device) may be provided on the compressor downstream side of the turbocharger 30. In this case, the target compressor downstream pressure (target pressure on the compressor output side) is calculated on the basis of the power difference between the target compressor power and the actual compressor power, and the assist power is calculated on the basis of the target compressor downstream pressure. Thus, the downstream pressure of the compressor impeller 31 (compressor output pressure) can be controlled to pressure adapted to the power difference, and proper power assist which is not excessive or insufficient can be realized.

It is also possible to calculate the power difference between the target turbine power and the actual turbine power of the turbocharger 30 and, on the basis of the power difference, calculate the motor assist amount.

A configuration may be also employed in which a compressor rotational speed is calculated as the assist amount and the driving of the auxiliary compressor 38 (motor 38a) is controlled so as to realize the compressor rotational speed.

The target compressor power and the actual compressor power may be calculated by map computation.

The target boost pressure may be calculated on the basis of the target fuel injection amount calculated from the target torque.

A configuration of calculating the target compressor upstream pressure on the basis of engine operating conditions and the like may be also employed. The assist power is calculated on the basis of the target compressor upstream pressure. In this case, the actual compressor upstream pressure is measured by a sensor or the like, and feedback control may be performed so that the measurement value becomes the target compressor upstream pressure. With the configuration, the compressor upstream pressure can be controlled to a desired pressure. Consequently, the proper power assist which is not excessive or insufficient can be realized.

At the time of calculating the assist power, a pressure loss amount (an amount of pressure loss occurring in the intake pipe upstream part) and an exhaust power may be added as computation parameters. As the relations of the parameters used to calculate the assist power, FIGS. 3 to 6 may be used.

As means for further improving the operation characteristics of the engine, the fuel injection amount may be corrected on the basis of the deviation between the target boost pressure calculated from the target torque and an actual boost pressure at each time. Alternately, the fuel injection amount may be corrected on the basis of the deviation between the target fuel pressure of the fuel supply source (for example, a common rail that stores high-pressure fuel) calculated from the target torque and an actual fuel pressure at each time.

What is claimed is:

1. A controller for an internal combustion engine with a supercharger, the controller being applied to an internal combustion engine having a supercharger for supercharging intake air by exhaust power and an auxiliary supercharging device provided upstream or downstream of the supercharger in an intake path and operated by using power other than exhaust as a power source, and the controller controlling output torque of the internal combustion engine by adjusting a fuel injection amount of fuel injection means, comprising:
target power calculating means that calculates target power of the supercharger;
actual power calculating means that calculates actual power of the supercharger;
assist amount calculating means that calculates an assist amount of the auxiliary supercharging device on the basis of target power and actual power of the supercharger; and
assist control means that controls the auxiliary supercharging device by the calculated assist amount.

2. A controller for an internal combustion engine with a supercharger according to claim 1, further comprising:
means that calculates a target fuel injection amount on the basis of target toque corresponding to a request of a driver; and
means that executes fuel injection amount control by the fuel injection means on the basis of the calculated target fuel injection amount,
wherein the target power calculating means calculates target power of the supercharger on the basis of the target fuel injection amount.

3. A controller for an internal combustion engine with a supercharger according to claim 2, further comprising
means that calculates a target boost pressure on the basis of the target fuel injection amount, wherein
the target power calculating means calculates target power of the supercharger on the basis of the target boost pressure and a target air volume calculated from an operating state of an internal combustion engine.

4. A controller for an internal combustion engine with a supercharger according to claim 1, wherein
the assist amount calculating means includes means that calculates target pressure in an intake path extending between the supercharger and the auxiliary supercharging device on the basis of a power difference between target power and actual power of the supercharger, and means that calculates an assist amount of the auxiliary supercharging device on the basis of the calculated target pressure.

5. A controller for an internal combustion engine with a supercharger according to claim 4, wherein
the higher the target pressure is, the more the assist amount calculating means increases the assist amount of the auxiliary supercharging device.

6. A controller for an internal combustion engine with a supercharger according to claim 4, further comprising
means that calculates an amount of pressure loss which occurs upstream of the supercharger in the intake path, wherein
the assist amount calculating means adds the pressure loss amount as a computation parameter and calculates an assist amount of the auxiliary supercharging device on the basis of the target pressure and the pressure loss amount.

7. A controller for an internal combustion engine with a supercharger, according to claim 1, further comprising
means that obtains an exhaust parameter of exhaust from the internal combustion engine by estimation or measurement, wherein
the actual power calculating means calculates actual power of the supercharger on the basis of the exhaust parameter.

8. A controller for an internal combustion engine with a supercharger according to claim 1, the controller being applied to an internal combustion engine using, as the supercharger, a turbocharger having a turbine wheel rotated by exhaust power and a compressor impeller coupled to the turbine wheel via a shaft, and performing supercharging by compressing intake air by rotation of the compressor impeller, wherein
turbo models of components of the turbocharger are used, the turbo models express flow of power from the turbine wheel to the compressor impeller,
the actual power calculating means calculates the actual power of the supercharger by using, at least, a turbine model of the turbine wheel among the turbo models, and
the target power calculating means calculates target power of the supercharger by using, at least, a compressor model of the compressor impeller among the turbo models.

9. A controller for an internal combustion engine with a supercharger according to claim 8, wherein
the actual power calculating means calculates actual power of the supercharger by forward calculation of the turbo model by using exhaust information as an input parameter, and the target power calculating means calculates target power of the supercharger by inverse calculation of the turbo model by using boost pressure information and intake information as input parameters.

10. A controller for an internal combustion engine with a supercharger, applied to an internal combustion engine having a supercharger for supercharging intake air by exhaust power and an auxiliary supercharging device provided upstream or downstream of the supercharger in an intake path and operated by power other than exhaust as a power source, and controlling output torque of the internal combustion engine by adjusting a fuel injection amount of fuel injection means, the controller comprising:
target power calculating means that calculates target pressure in an intake path between the supercharger and the auxiliary supercharging device;
assist amount calculating means that calculates an assist amount of the auxiliary supercharging device on the basis of the calculated target pressure; and
assist control means that controls the auxiliary supercharging device with the calculated assist amount.

11. A controller for an internal combustion engine with a supercharger according to claim 10, wherein
the target pressure calculating means calculates the target pressure on the basis of operating state of the internal combustion engine, and the higher the target pressure is, the more the assist amount calculating means increases the assist amount of the auxiliary supercharging device.

12. A controller for an internal combustion engine with a supercharger according to claim 1, wherein
the auxiliary supercharging device is an auxiliary compressor for compressing intake air by using power other than exhaust as a power source.

13. A controller for an internal combustion engine with a supercharger according to claim 1, further comprising
means that regulates a fuel injection amount of the fuel injecting means on the basis of actual boost pressure adjusted by the supercharger in order to reduce an amount of smoke included in exhaust from the internal combustion engine.

14. A controller for an internal combustion engine with a supercharger according to claim 1, wherein
a fuel injection amount of the fuel injecting means is corrected on the basis of a deviation between target boost pressure calculated from target torque corresponding to a request of a driver and actual boost pressure at each time.

15. A controller for an internal combustion engine with a supercharger according to claim 1, wherein
a fuel injection amount of the fuel injecting means is corrected on the basis of a deviation between target fuel pressure of a fuel supply source calculated from target torque corresponding to a request of a driver and actual fuel pressure at each time.

16. A controller for an internal combustion engine with a supercharger according to claim 1, further comprising
means that determines whether actual boost pressure has reached predetermined reference pressure or not,
wherein the power assist of the auxiliary supercharging device is stopped before it is determined that the actual boost pressure has reached the reference pressure.
